(19) United States
(12) Patent Application Publication
(10) Pub. No.: US 2002/0101787 A1
(43) Pub. Date: Aug. 1, 2002

(54) Information processing device and time of day control method

(76) Inventors: Ryousuke Fujii, Tokyo (JP); Toyoshi Makino, Tokyo (JP); Masahiro Fukuda, Tokyo (JP); Takahiro Hiramatsu, Tokyo (JP)

Correspondence Address: BIRCH STEWART KOLASCH & BIRCH, PO BOX 747, FALLS CHURCH, VA, 22040-0747, US

(21) Appl. No.: 09/970,686

(22) Filed: Oct. 5, 2001

(30) Foreign Application Priority Data
Jan. 31, 2001 (JP) 2001-24380

(51) Int. Cl. G04F 10/00; G06F 1/04; H04L 7/00

(52) U.S. Cl. 368/107; 713/500; 375/354

(57) ABSTRACT

A time difference between a broadcast time included in a digital broadcast signal and a device time peculiar to an information processing device is calculated, and an estimated broadcast time is calculated according to the time difference and the device time. Therefore, the estimated broadcast time is calculated without adjusting the device time to the broadcast time. Accordingly, when the device requests a broadcast time, an operation base on the estimated broadcast time can be performed without exerting an influence of the broadcast time on constitutional elements or having a redundant configuration of a clock system.

### BACKGROUND OF THE INVENTION

1. Field of the Invention

The present invention relates to both an information processing device with a function for receiving a digital broadcast signal and a time of day control method in which an operation based on a broadcast time included in the digital broadcast signal is performed.

2. Description of Related Art

FIG. 5 is a block diagram of a conventional information processing device. In FIG. 5, 1 indicates a broadcast time extracting unit for receiving a digital broadcast signal and extracting a time offset table included in the digital broadcast signal. The time offset table denotes a broadcast time of day which indicates a current time. Therefore, digital television programs are broadcasted according to the broadcast time of day. 2 indicates a device time obtaining unit for obtaining a device time peculiar to the conventional information processing device from an internal clock and adjusting the device time to the time offset table. An operation based on the device time is performed in the conventional information processing device. 3 indicates a device time requesting unit for requesting the device time of the device time obtaining unit 2.

Next, an operation of the conventional information processing device will be described below.

In the broadcast time extracting unit 1, when a digital broadcast signal is received, a time offset table included in the digital broadcast signal is extracted.

In the device time obtaining unit 2, when the time offset table is extracted in the broadcast time extracting unit 1, a device time obtained from an internal clock is adjusted so as to agree with the time offset table. Thereafter, when a request indicating the outputting of the device time is sent from the device time requesting unit 3 and is received in the device time obtaining unit 2, the device time, which is peculiar to the conventional information processing device and is adjusted to the time offset table, is output from the device time obtaining unit 2 to the device time requesting unit 3.

Therefore, an operation based on the time offset table can be performed in the device time requesting unit 3.

However, because the device time obtained from the internal clock is adjusted so as to agree with the time offset table, independency of the internal clock is lost, and there is a probability that constitutional elements of the device are not correctly controlled according to the device time. Also, a problem has arisen that it is sometimes impossible to perform an operation based on a master clock on a network.

To prevent the above problems, a clock privately used for the broadcast time is prepared independently of the internal clock, and the clock privately used for the broadcast time is adjusted so as to agree with the time offset table. In this case, though the above problems can be prevented, another problem has arisen that a clock system in the conventional information processing device has a redundant configuration.

### SUMMARY OF THE INVENTION

An object of the present invention is to provide, with due consideration to the drawbacks of the conventional information processing device, an information processing device and a time of day control method in which an operation base on a time offset table denoting a broadcast time is performed without exerting an influence of the time offset table on constitutional elements or having a redundant configuration of a clock system.

The object is achieved by the provision of an information processing device comprising broadcast time extracting means for receiving a digital broadcast signal and extracting a broadcast time including in the digital broadcast signal, device time obtaining means for obtaining a device time peculiar to the information processing device from an internal clock, time difference calculating means for calculating a time difference between the broadcast time extracted by the broadcast time extracting means and the device time obtained by the device time obtaining means, and estimated broadcast time calculating means for calculating an estimated broadcast time according to the device time obtained by the device time obtaining means and the time difference calculated by the time difference calculating means.

The estimated broadcast time is calculated without adjusting the device time obtained from the internal clock to the broadcast time. Accordingly, an operation base on the broadcast time can be performed without exerting an influence of the broadcast time on constitutional elements of the information processing device or having a redundant configuration of a clock system of the information processing device.

It is preferred that the estimated broadcast time is calculated by the estimated broadcast time calculating means by using the time difference calculated by the time difference calculating means just before the setting of a stopped state of a function of the broadcast time extracting means in cases where the function of the broadcast time extracting means is set to the stopped state.

Therefore, even though the function of the broadcast time extracting means is set to the stopped state, the estimated broadcast time can be calculated.

It is preferred that the information processing device further comprises non-volatile storing means for storing the time difference calculated by the time difference calculating means in cases where a request indicating the end of an operation of the information processing device is generated.

Therefore, when the supply of an electric power to the information processing device is restarted, the estimated broadcast time can be calculated by using the time difference stored in the non-volatile storing means.

It is preferred that the estimated broadcast time is corrected by the estimated broadcast time calculating means according to information of a daylight saving time in cases where the information of the daylight saving time is included in the digital broadcast signal.

Therefore, an operation matching with the daylight saving time can be performed.

It is preferred that the broadcast time extracted by the broadcast time extracting means matches with a daylight saving time.

Therefore, an operation matching with the daylight saving time can be performed.

It is preferred that a type of string of bits expressing the information of the daylight saving time is the same as that expressing the time difference calculated by the time difference calculating means.

Therefore, the configuration of the information processing device can be simplified.

It is preferred that the information processing device further comprises operation performing means for performing an operation according to the estimated broadcast time calculated by the estimated broadcast time calculating means.

Therefore, an operation base on the broadcast time can be performed.

The object is also achieved by the provision of a time of day control method, comprising the steps of receiving a digital broadcast signal, extracting a broadcast time from the digital broadcast signal, obtaining a device time peculiar to a device from an internal clock of the device, calculating a time difference between the broadcast time and the device time obtained by the device time, and calculating an estimated broadcast time according to the device time and the time difference.

The estimated broadcast time is calculated without adjusting the device time obtained from the internal clock to the broadcast time. Accordingly, an operation base on the broadcast time can be performed without exerting an influence of the broadcast time on constitutional elements of the device or having a redundant configuration of a clock system of the device.

It is preferred that the step of calculating the estimated broadcast time includes a step of calculating the estimated broadcast time by using the time difference calculated just before the setting of a stopped state of a function of extracting the broadcast time in cases where the function of extracting the broadcast time is set to the stopped state.

Therefore, even though the function of extracting the broadcast time is set to the stopped state, the estimated broadcast time can be calculated.

It is preferred that the step of calculating the time difference includes a step of storing the calculated time difference in a non-volatile storage in cases where a request indicating the end of an operation of the device is generated.

Therefore, when the supply of an electric power to the device is restarted, the estimated broadcast time can be calculated by using the time difference stored in the non-volatile storage.

It is preferred that the step of calculating the estimated broadcast time includes a step of correcting the estimated broadcast time according to information of a daylight saving time in cases where the information of the daylight saving time is included in the digital broadcast signal.

Therefore, an operation matching with the daylight saving time can be performed.

It is preferred that the broadcast time extracted from the digital broadcast signal matches with a daylight saving time.

Therefore, an operation matching with the daylight saving time can be performed.

It is preferred that a type of string of bits expressing the information of the daylight saving time is the same as that expressing the calculated time difference.

Therefore, the processing of calculating the estimated broadcast time can be simplified.

It is preferred that the time of day control method further comprises a step of performing an operation based on the estimated broadcast time.

Therefore, an operation base on the broadcast time can be performed.

### BRIEF DESCRIPTION OF THE DRAWINGS

FIG. 1 is a block diagram of an information processing device according to a first embodiment of the present invention;

FIG. 2 is a flowchart showing a time of day control method according to the first embodiment of the present invention;

FIG. 3 is a block diagram of an information processing device according to a third embodiment of the present invention;

FIG. 4 is a block diagram of an information processing device according to a fourth embodiment of the present invention; and

FIG. 5 is a block diagram of a conventional information processing device.

### DETAILED DESCRIPTION OF THE PREFERRED EMBODIMENTS

Embodiments of the present invention will now be described with reference to the accompanying drawings.

Embodiment 1

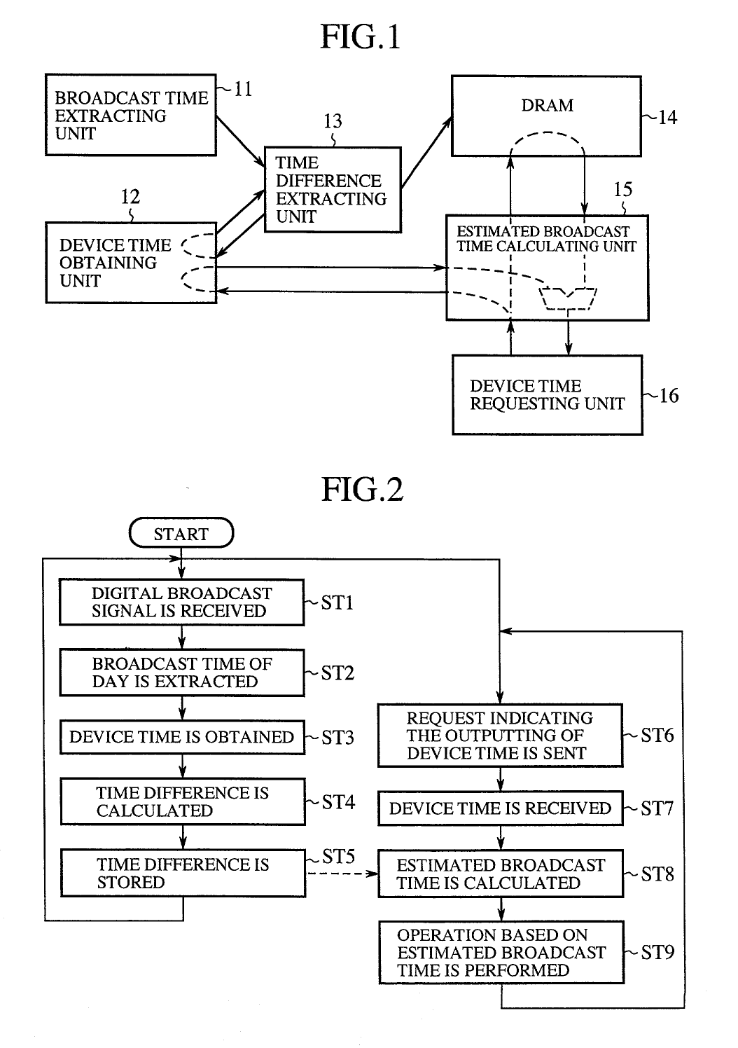

FIG. 1 is a block diagram of an information processing device according to a first embodiment of the present invention. In FIG. 1, 11 indicates a broadcast time extracting unit (or broadcast time extracting means) for receiving a digital broadcast signal and extracting a time offset table denoting a broadcast time of day from the digital broadcast signal. 12 indicates a device time obtaining unit (or device time obtaining means) for obtaining a device time of day peculiar to the information processing device from an internal clock. An operation base on the device time is performed in the information processing device.

13 indicates a time difference extracting unit (or time difference calculating means) for calculating a time difference between the broadcast time extracted in the broadcast time extracting unit 11 and the device time obtained in the device time obtaining unit 12. 14 indicates a dynamic random access memory (DRAM) for storing the time difference calculated in the time difference extracting unit 13. 15 indicates an estimated broadcast time calculating unit (estimated broadcast time calculating means) for calculating an estimated broadcast time according to the device time obtained in the device time obtaining unit 12 and the time difference stored in the DRAM 14. 16 indicates a device time requesting unit (or operation performing means) for requesting the estimated broadcast time calculating unit 15 to output a device time of day to the device time requesting unit 16.

FIG. 2 is a flow chart showing a time of day control method according to the first embodiment of the present invention. Next, an operation of the information processing device will be described with reference to FIG. 1 and FIG. 2. In the broadcast time extracting unit 11, when a digital broadcast signal is received in a step ST1, a time offset table denoting a broadcast time of day is extracted from the digital broadcast signal in a step ST2.

Also, in the device time obtaining unit 12, a device time peculiar to the information processing device is obtained from an internal clock in a step ST3.

After the extraction of the time offset table in the broadcast time extracting unit 11 and the obtaining of the device time in the device time obtaining unit 12, a time difference between the broadcast time and the device time is calculated in the time difference extracting unit 13 in a step ST4, and the time difference is stored in the DRAM 14 in a step ST5.

Thereafter, when a request indicating the outputting of a device time of day is sent from the device time requesting unit 16 to the estimated broadcast time calculating unit 15 in a step ST6, the device time sent from the device time obtaining unit 12 is received in the estimated broadcast time calculating unit 15 in a step ST7. Thereafter, in a step ST8, an estimated broadcast time is calculated in the estimated broadcast time calculating unit 15 according to the device time and the time difference stored in the DRAM 14.

Thereafter, the estimated broadcast time is output to the device time requesting unit 16 in response to the request of the device time requesting unit 16, and an operation based on the estimated broadcast time is performed in the device time requesting unit 16 in a step ST9.

As is described above, in the first embodiment, the estimated broadcast time is calculated according to the time difference between the broadcast time and the device time peculiar to the information processing device. Therefore, because the device time based on the internal clock is not adjusted to the broadcast time, independency of the internal clock is maintained in the information processing device. Also, no clock privately used for the broadcast time is prepared. Accordingly, an operation base on the time offset table can be performed in the information processing device without exerting an influence of the time offset table on constitutional elements of the information processing device or having a redundant configuration of a clock system of the information processing device.

Embodiment 2

In the first embodiment, a time difference between the broadcast time extracted in the broadcast time extracting unit 11 and the device time obtained in the device time obtaining unit 12 is calculated in the time difference extracting unit 13 on condition that the function of extracting the broadcast time in the broadcast time extracting unit 11 is set to an operating state. Therefore, in cases where the function of the broadcast time extracting unit 11 is set to a stopped state, it is impossible in the first embodiment to calculate the time difference between the broadcast time and the device time.

To avoid this problem, in the second embodiment, in cases where the function of the broadcast time extracting unit 11 is set to a stopped state, because the time difference calculated in the time difference extracting unit 13 just before the setting of the stopped state in the broadcast time extracting unit 11 is stored in the DRAM 14 as an updated time difference, an estimated broadcast time is calculated in the estimated broadcast time calculating unit 15 according to the device time and the updated time difference stored in the DRAM 14.

Accordingly, even though the function of the broadcast time extracting unit 11 is set to a stopped state, the estimated broadcast time can be calculated. Therefore, for example, even though no digital broadcast signal is received, an operation using an electronic program guide can be performed. Also, even though the reception of the digital broadcast signal is stopped, an operation for waiting for a specific program to be broadcasted according to the electronic program guide can be performed.

Embodiment 3

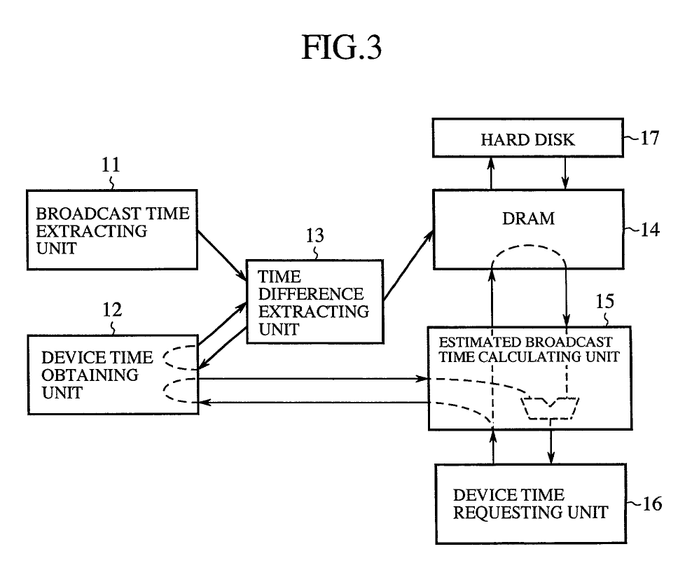

FIG. 3 is a block diagram of an information processing device according to a third embodiment of the present invention. The constituent elements, which are the same as those shown in FIG. 1, are indicated by the same reference numerals as those of the constituent elements shown in FIG. 1, and additional description of those constituent elements is omitted.

In the second embodiment, the estimated broadcast time is calculated in the estimated broadcast time calculating unit 15 by using a time difference which is calculated in the time difference extracting unit 13 just before the setting of the stopped state in the broadcast time extracting unit 11. However, in cases where an electric power supplied to the information processing device is stopped, the time difference stored in the DRAM 14 is lost.

To avoid this problem, in the third embodiment, as shown in FIG. 3, a hard disk (or non-volatile storing means) 17 representing a non-volatile storage is connected with the DRAM 14 so as to store the time difference stored in the DRAM 14 when a request indicating the end of the operation of the device is received in the information processing device.

Therefore, even though an electric power supplied to the information processing device is stopped, a time difference finally calculated in the time difference extracting unit 13 is stored in the hard disk 17. Therefore, when the supply of an electric power to the information processing device is restarted, an estimated broadcast time can be immediately calculated in the estimated broadcast time calculating unit 15 by using the time difference stored in the hard disk 17.

Embodiment 4

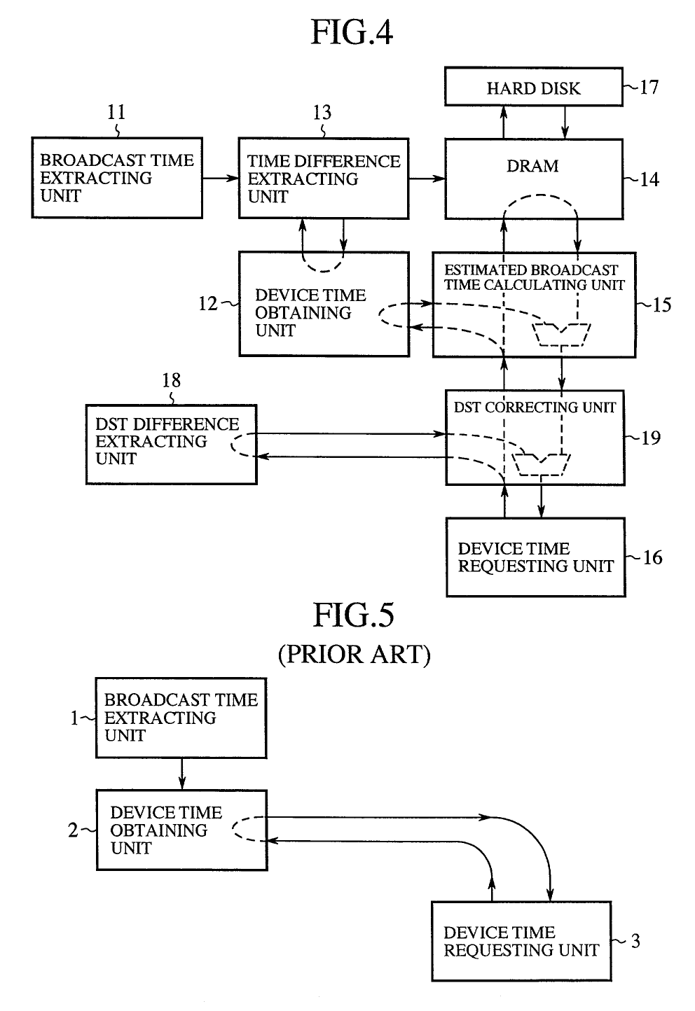

FIG. 4 is a block diagram of an information processing device according to a fourth embodiment of the present invention. The constituent elements, which are the same as those shown in FIG. 3, are indicated by the same reference numerals as those of the constituent elements shown in FIG. 3, and additional description of those constituent elements is omitted.

In FIG. 4, 18 indicates a daylight saving time (DST) difference extracting unit for receiving a digital broadcast signal including a DST difference (or DST information) between a standard time and a daylight saving time and extracting the DST difference from the digital broadcast signal. 19 indicates a daylight saving time (DST) correcting unit for correcting the estimated broadcast time calculated in the estimated broadcast time calculating unit 15 according to the DST difference extracted in the DST difference extracting unit 18. Here, estimated broadcast time calculating means comprises the estimated broadcast time calculating unit 15, the DST difference extracting unit 18 and the DST correcting unit 19.

Next, an operation of the information processing device will be described below.

In the estimated broadcast time calculating unit 15, an estimated broadcast time is calculated in the same manner as in the first embodiment. In cases where the time of day is determined according to a daylight saving time in a specific season in a region or country, a standard time of day adopted in other seasons differs from a daylight saving time of day adopted in the specific season, and the estimated broadcast time calculated in the estimated broadcast time calculating unit 15 matches with the standard time even in the specific season.

In this case, a digital broadcast signal includes a DST difference between the standard time and the daylight saving time in the specific season. Therefore, the DST difference is extracted from the digital broadcast signal in the DST difference extracting unit 18, and the estimated broadcast time calculated in the estimated broadcast time calculating unit 15 is corrected according to the DST difference in the DST correcting unit 19. That is, the estimated broadcast time matching with the standard time is changed to an estimated broadcast time matching with the daylight saving time. Here, to simplify the processing performed in the information processing device, a type of string of bits expressing the time difference calculated in the time difference extracting unit 13 is the same as that expressing the DST difference.

Accordingly, an operation matching with the daylight saving time can be performed in the information processing device in the specific season in which the daylight saving time is adopted.

Embodiment 5

In the fourth embodiment, the DST difference included in the digital broadcast signal is extracted in the DST difference extracting unit 18, and the estimated broadcast time calculated in the estimated broadcast time calculating unit 15 is corrected according to the DST difference in the DST correcting unit 19. However, in cases where the time offset table extracted in the broadcast time extracting unit 11 matches with the daylight saving time, the configuration of the DST difference extracting unit 18 and the DST correcting unit 19 is not required. Therefore, the estimated broadcast time matching with the daylight saving time can be obtained in the same configuration as that of the first, second or third embodiment.

What is claimed is:

1. An information processing device comprising:
broadcast time extracting means for receiving a digital broadcast signal and extracting a broadcast time including in the digital broadcast signal;
device time obtaining means for obtaining a device time peculiar to the information processing device from an internal clock;
time difference calculating means for calculating a time difference between the broadcast time extracted by the broadcast time extracting means and the device time obtained by the device time obtaining means; and
estimated broadcast time calculating means for calculating an estimated broadcast time according to the device time obtained by the device time obtaining means and the time difference calculated by the time difference calculating means.

2. An information processing device according to claim 1, wherein the estimated broadcast time is calculated by the estimated broadcast time calculating means by using the time difference calculated by the time difference calculating means just before the setting of a stopped state of a function of the broadcast time extracting means in cases where the function of the broadcast time extracting means is set to the stopped state.

3. An information processing device according to claim 2, further comprising:
non-volatile storing means for storing the time difference calculated by the time difference calculating means in cases where a request indicating the end of an operation of the information processing device is generated.

4. An information processing device according to claim 1, wherein the estimated broadcast time is corrected by the estimated broadcast time calculating means according to information of a daylight saving time in cases where the information of the daylight saving time is included in the digital broadcast signal.

5. An information processing device according to claim 1, wherein the broadcast time extracted by the broadcast time extracting means matches with a daylight saving time.

6. An information processing device according to claim 4, wherein a type of string of bits expressing the information of the daylight saving time is the same as that expressing the time difference calculated by the time difference calculating means.

7. An information processing device according to claim 1, further comprising:
operation performing means for performing an operation according to the estimated broadcast time calculated by the estimated broadcast time calculating means.

8. A time of day control method, comprising the steps of:
receiving a digital broadcast signal;
extracting a broadcast time from the digital broadcast signal;
obtaining a device time peculiar to a device from an internal clock of the device;
calculating a time difference between the broadcast time and the device time obtained by the device time; and
calculating an estimated broadcast time according to the device time and the time difference.

9. A time of day control method according to claim 8, wherein the step of calculating the estimated broadcast time includes a step of calculating the estimated broadcast time by using the time difference calculated just before the setting of a stopped state of a function of extracting the broadcast time in cases where the function of extracting the broadcast time is set to the stopped state.

10. A time of day control method according to claim 9, wherein the step of calculating the time difference includes a step of storing the calculated time difference in a non-volatile storage in cases where a request indicating the end of an operation of the device is generated.

11. A time of day control method according to claim 8, wherein the step of calculating the estimated broadcast time includes a step of correcting the estimated broadcast time according to information of a daylight saving time in cases where the information of the daylight saving time is included in the digital broadcast signal.

12. A time of day control method according to claim 8, wherein the broadcast time extracted from the digital broadcast signal matches with a daylight saving time.

13. A time of day control method according to claim 11, wherein a type of string of bits expressing the information of the daylight saving time is the same as that expressing the calculated time difference.

14. A time of day control method according to claim 8, further comprising a step of
performing an operation based on the estimated broadcast time.
